(19) United States
(12) Patent Application Publication
(10) Pub. No.: US 2015/0244685 A1
(43) Pub. Date: Aug. 27, 2015

(54) GENERALIZED CRYPTOGRAPHIC FRAMEWORK

(71) Applicant: INTERDIGITAL PATENT HOLDINGS, Wilmington, DE (US)

(72) Inventors: Yogendra C. Shah, Exton, PA (US); Vinod K. Choyi, Norristown, PA (US); Yousif Targali, Cliffwood, NJ (US)

(21) Appl. No.: 14/428,782

(22) PCT Filed: Sep. 18, 2013
(86) PCT No.: PCT/US2013/060341

§ 371 Date: Mar. 17, 2015

Related U.S. Application Data
(60) Provisional application No. 61/702,597, filed on Sep. 18, 2012.

(51) Int. Cl. H04L 29/06

(52) U.S. Cl. CPC H04L 63/0428; H04L 63/0861

(57) ABSTRACT

A user equipment (UE, 301) comprises communication circuitry that establishes communication with a network, at least one processor, a plurality of security modules (104), a plurality of cryptographic function modules (304), and a cryptographic framework module (302). The security modules (104) may each implement a different security method for securely communicating or authenticating with the network. Each different security method may require execution of one or more of a plurality of different cryptographic functions (302). Each of the cryptographic function modules may execute one or more of the plurality of different cryptographic functions. For example, the cryptographic framework module (302) may receive a request from a select one security module (104). In response to the request, the cryptographic framework module (302) may automatically invoke a select one of the cryptographic function modules (304) iteratively, as required, to provide a requested cryptographic type (such as encryption, hashing, digital signature) and strength.

### CROSS REFERENCE TO RELATED APPLICATIONS

This application claims the benefit of U.S. Provisional Patent Application Ser. No. 61/702,597 filed Sep. 18, 2012, the contents of which are hereby incorporated by reference as if set forth in its entirety herein.

### BACKGROUND

As wireless technologies continue to proliferate, new security protocols or methods are introduced that use a variety of different cryptographic functions. Often new security protocols use different cryptographic functions with varying strength and key lengths. In order to support security methods, vendors have traditionally chosen to implement security methods such that they are tightly-coupled with the underlying cryptographic functions, resulting in an inflexible approach. For example, when a cryptographic function that is associated with a security method requires to be updated, then the entire implementation may have to be altered. Similarly, when new security methods or protocols are developed, implementations may have to be redesigned. Further, different applications and their associated security protocols may use the same cryptographic function, but with varying key lengths. It may be particularly difficult on vendors of security modules to implement functions with different key lengths on resource constrained smart cards such as, for example, a universal integrated circuit card (UICC) or a subscriber identity module (SIM) card.

### SUMMARY

Systems, methods and apparatus embodiments are described herein for implementing security protocols, for example, to establish secure communications between a user equipment (UE) and a network. In an example embodiment, a UE comprises communication circuitry that establishes communication between the UE and a network, at least one processor, a plurality of security modules, a plurality of cryptographic function modules, and a cryptographic framework module. The security modules are each capable of executing on the at least one processor and each implement a different security method for securely communicating or authenticating with the network. Each different security method requires execution of one or more of a plurality of different cryptographic functions. Each of the cryptographic function modules are capable of executing on the at least one processor and each are configured to execute one or more of the plurality of different cryptographic functions. The cryptographic framework module executes on the at least one processor and provides a common application programming interface (API) to the security modules. For example, the cryptographic framework module may receive a request from a select one security module specifying a desired cryptographic type and a desired cryptographic strength required to perform the security method implemented by that security module in order to authenticate with the network. In response to the request, the cryptographic framework module may automatically invoke a select one of the cryptographic function modules iteratively, as required, to provide the requested cryptographic type and strength. In accordance with the example embodiment, the cryptographic framework module returns a cryptographic result and information indicative of the cryptographic function used and strength achieved to the select one security module. In accordance with an example embodiment, the plurality of security modules reside on a kernel of the UE, the cryptographic framework module resides on a trusted execution environment of the UE, and the cryptographic function modules reside on a universal integrated circuit card (UICC).

In another example embodiment, a UE and a network entity communicate via a network, and at least one security protocol of the network entity is implemented to secure communications between the UE and the network entity. The UE receives, via an application programming interface (API) call, a request for a cryptographic result. The requested cryptographic result is associated with at least one parameter. Based on the at least one parameter, the UE selects a cryptographic function that satisfies the request. The UE invokes the selected cryptographic function to generate the requested cryptographic result. The requested cryptographic result and an identity of the invoked cryptographic function is returned to an application.

### BRIEF DESCRIPTION OF THE DRAWINGS

A more detailed understanding may be had from the following description, given by way of example in conjunction with the accompanying drawings wherein:

FIG. 1 is a block diagram of a system comprising a user equipment (UE) and a network security entity, wherein various entities, such as a generalized cryptographic architecture, reside on the UE for implementing authentication and secure communications according to an example embodiment;

FIG. 2 is a block diagram of an example Open Mobile Application Programming Interface (API) Architecture;

FIG. 3 is a block diagram of the cryptographic architecture shown in FIG. 1, wherein the cryptographic architecture comprises a cryptographic framework module, a key vault, and various cryptographic function modules in accordance with an example embodiment;

FIG. 4 is a flow diagram that illustrates the cryptographic framework module shown in FIG. 3 implementing a Generic Bootstrapping Architecture (GBA) protocol and an Extensible Authentication Protocol (EAP) that use the same cryptographic function (CF) in accordance with an example embodiment;

FIG. 5 is a block diagram of a portion of a UE that includes the cryptographic framework module and various security modules that each implement a different security protocol according to an example embodiment;

FIG. 6 is a flow diagram illustrating the cryptographic framework module using various API calls to implement a security method and a cryptographic function in accordance with an example embodiment;

FIG. 7 is another flow diagram illustrating the cryptographic framework module using various API calls and the key vault to implement another security method and another cryptographic function in accordance with another example embodiment;

FIG. 8 is a flow diagram illustrating messages according to an example embodiment, wherein the messages comprise cryptographic information and the messages are exchanged between the network security entity and one of the security methods which are depicted in FIG. 1;

FIG. 9 is a flow diagram that illustrates the cryptographic framework module implementing a multiple output cryptographic function according to an example embodiment;

FIG. 10A is a system diagram of an example communications system in which one or more disclosed embodiments may be implemented;

FIG. 10B is a system diagram of an example wireless transmit/receive unit (WTRU) that may be used within the communications system illustrated in FIG. 10A; and

FIG. 10C is a system diagram of an example radio access network and an example core network that may be used within the communications system illustrated in FIG. 10A.

### DETAILED DESCRIPTION OF ILLUSTRATIVE EMBODIMENTS

The ensuing detailed description is provided to illustrate example embodiments and is not intended to limit the scope, applicability, or configuration of the invention. Various changes may be made in the function and arrangement of elements and steps without departing from the spirit and scope of the invention.

Embodiments are described herein that enable the use of different crytographic functions by various security protocols via a common cryptographic framework. In accordance with one embodiment, a generalized key derivation architecture enables implementation of various security protocols such as, for example, the Extensible Authentication Protocol (EAP), the Generic Bootstrapping Architecture (GBA), internet protocol security (IPSec), Transport Layer Security (TLS)/Secure Sockets Layer (SSL), or any other appropriate security protocols. Security protocols may also be referred to herein as security methods, without limitation. The generalized architecture may be extended to enable additional security protocols and methods so that different cryptographic mechanisms for authentication or generation of session keys may be performed using the same architecture. In an example embodiment, the architecture is extended via a cryptographic framework module. The cryptographic framework module enables the implementation of a plurality of cryptographic functions that may be invoked by security protocols, for example, via a cryptographic application programming interface (API). The cryptographic framework module may be implemented in a secure hardware module or in software, or in any appropriate combination thereof

Current approaches to incorporating new technologies, such as new security protocols for example, into systems, such as a user equipment (UE) for example, are inefficient and cumbersome. For example, security protocols are often tightly-coupled with the underlying cryptographic functions, such that an entire implementation may have to be altered when a cryptographic function is updated or altered. Cryptographic functions may be altered to strengthen encryption. By way of further example, the implementation (e.g., hardware or software) of a cryptographic function may change, which may require further changes to a UE when the UE implements security protocols that are tightly coupled with the underlying cryptographic function. Similarly, when new security methods or protocols are developed, implementations of a UE may have to redesigned. Another issue with the current approach of tightly coupling security protocols with the underlying cryptographic function is that it may be particularly difficult on vendors of security modules to implement cryptographic functions with different key lengths on resource constrained smart cards (e.g., UICC/SIM). Different applications and their associated security protocols may use the same cryptographic function, but with varying key lengths. For example, the extensible authentication protocol (EAP) authentication and key agreement (AKA) (EAP-AKA) and EAP-AKA prime (EAP-AKA′) use the same Pseudo-Random-Function (PRF) based on hash-based message authentication code (HMAC) secure hash algorithm (SHA) (HMAC-SHA), but with different output key lengths.

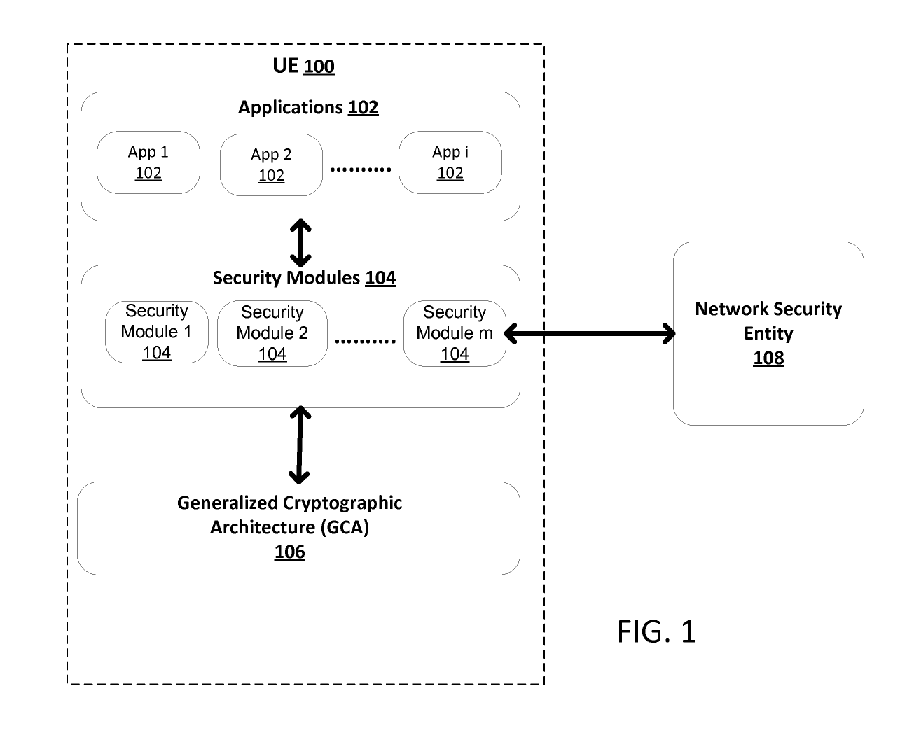

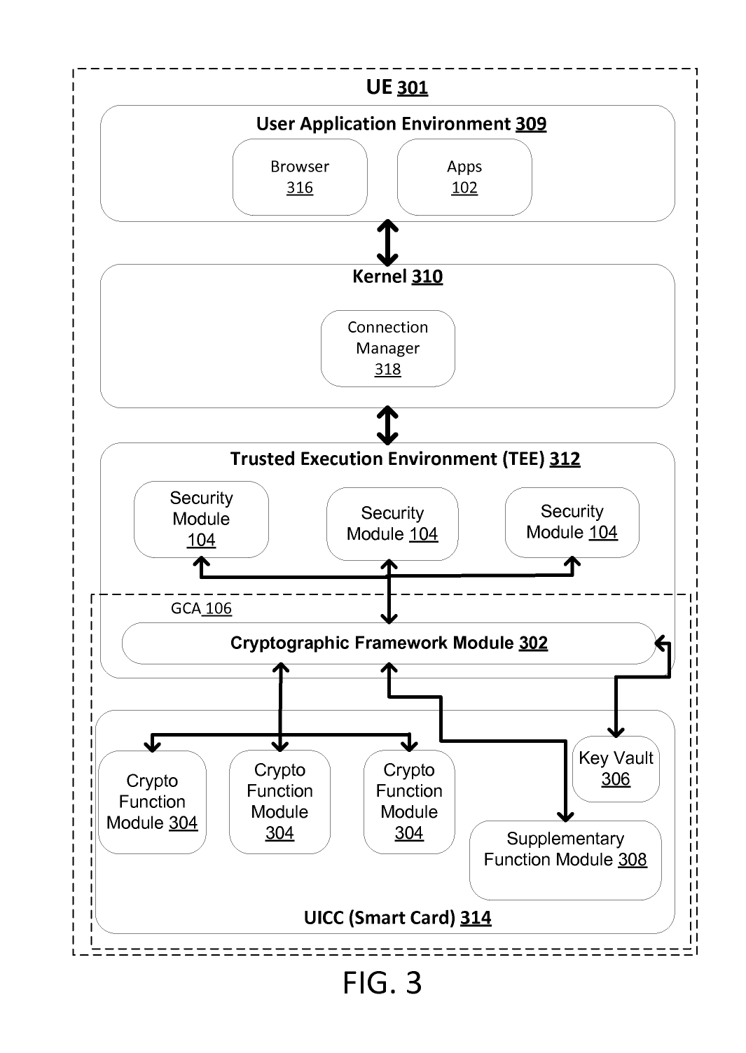

FIG. 1 is a block diagram of a system comprising a network security entity 108 and a user equipment (UE) 100 for communicating with a network, and in particular the network security entity 108. The term user equipment (UE), as used herein, may refer to any appropriate wireless transmit/receive unit (WTRU) or device that communicates with a network, without limitation. The UE 100 includes a generalized cryptographic architecture (GCA) 106, applications 102, and security modules 104, which reside on the UE 100 for implementing authentication and for enabling secure communications according to an example embodiment. The UE 100 further includes at least one processor and communication circuitry that establishes communication between the UE 100 and the network security entity 108. In accordance with the illustrated embodiment, each of the security modules 104 may implement a different security protocol for authenticating with the network security entity 108, and each of the different security protocols may require execution of one or more of a plurality of different cryptographic functions (e.g., see FIG. 3). Example security protocols that may be implemented by the security modules 104 include the extensible authentication protocol (EAP), generic bootstrapping architecture (GBA), Internet Key Exchange, IPSec, 802.11i protocols, TLS/SSL (HTTPS) or the like. The network security entity 108 may be implemented by an authentication server, a bootstrapping server function (BSF), an IP security gateway, an access point (AP), a network application function (NAF), or the like. The applications 102 may use one or more of the security modules 104 to secure the communications between themselves and other endpoints. For example, the applications 102 may include a connection manager, a virtual private network (VPN) client application, or the like. The different security modules 104 may use substantially the same or similar cryptographic functions. Thus, different security methods that are implemented by the plurality of security modules may include at least one of a user authentication method, a device authentication method, a biometric authentication method, a session key generation method, an extensible authentication protocol (EAP), a generic bootstrapping architecture protocol (GBA), an IPSec protocol, an 802.11 connection manager, an OpenID method, an internet protocol (IP) security method, or the like.

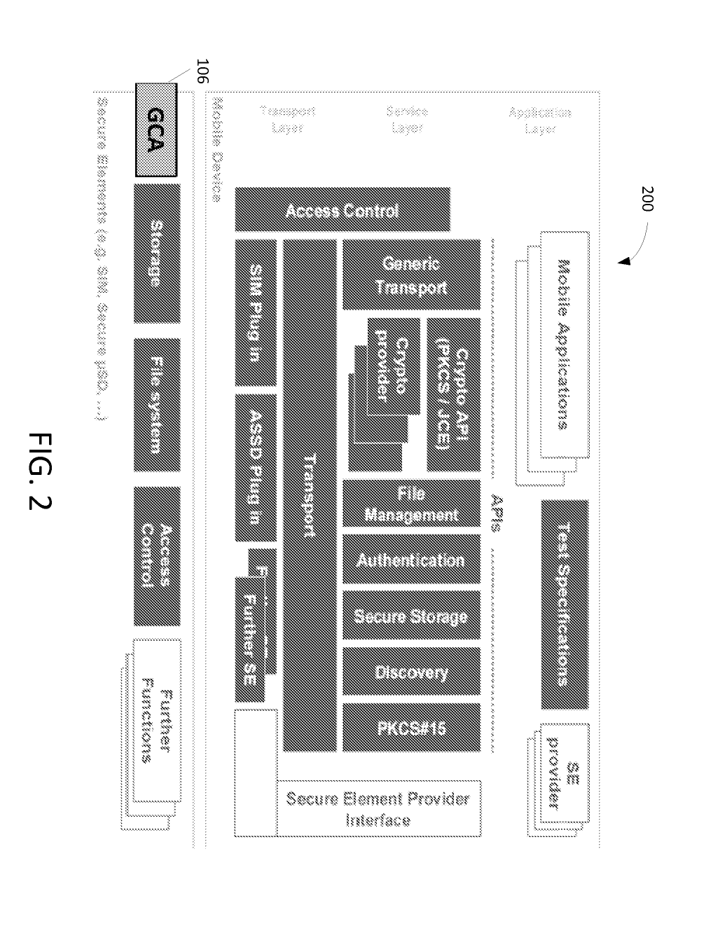

Referring also to FIG. 3, in accordance with the illustrated embodiment, the generalized cryptographic architecture 106 is independent of the security modules 104 and the applications 102. The cryptographic architecture 106 may be invoked by the security modules 104 via cryptographic API calls. For example, messaging between a security module 104 and the network security entity 108 may convey a strength of a cryptographic function that should be used and an identity of the cryptographic function that was executed. FIG. 2 illustrates how the cryptographic architecture 106 fits within an example Open Mobile API architecture 200 in accordance with an example embodiment.

With particular reference to FIG. 3, in accordance with the illustrated embodiment, a UE 301 includes the cryptographic architecture 106 that comprises a cryptographic framework module 108 and a plurality of cryptographic function modules 304. The UE 301 may further include a processor and communication circuitry that establishes communication between the UE 301 and a network. Each of the cryptographic function modules 304 may be configured to execute one or more of a plurality of different cryptographic functions For example, the plurality of cryptographic functions may include at least one of an encryption/decryption function, a block cipher, a stream cipher, a hashing function, a random number generator function, digital signature function, message authentication function, authenticated encryption function, a sponge function or a key derivation function. As used herein, an encryption function may refer to a function that encrypts and decrypts, and thus may also be referred to as encryption/decryption functions without limitation. The cryptographic architecture 106 may include a cryptographic API that interfaces with various authentication (security) protocols and cryptographic functions. The illustrated cryptographic architecture 106 further comprises a secure key vault 306 and a supplementary function module 308, for example, that aids the cryptographic framework module 302 and the cryptographic function modules 304. The supplementary function module 308 may execute functions such as, for example, a Pseudo-Random Generator function (PRNG), a public/private key generation function, or the like. The UE 301 may further include a user application environment 309, a kernel 310, a trusted execution environment (TEE) 312, and a UICC/smart card 314. In accordance with the illustrated embodiment, the security modules 104 and the cryptographic framework module 302 reside on the TEE 312; the cryptographic function modules 304, the supplementary function module 308, and the key vault 306 reside on the UICC/smart card 314; the applications 102 and a browser 316 reside on the user application environment 309; and the connection manager 318 (e.g., 3G, wi-fi, 802.11) resides on the kernel 310. It will be understood that modules of the UE 301 may be alternatively disposed as desired. For example, the cryptographic architecture 106 may be implemented within a secure hardware module, in software, or in any appropriate combination of both hardware and software. In accordance with an example embodiment, the cryptographic architecture 106 provides a common interface for the security modules 104 to use the cryptographic functions. The cryptographic architecture 106 enables the re-use of an existing cryptographic function without the need to implement or install a new function.

It will be understood that the security modules 104, and thus the security protocols that are implemented by the security modules 104, may be part of the cryptographic architecture 106 or separate from the cryptographic architecture 106. The security protocols may operate at different layers of the transmission control protocol (TCP) or open systems interconnect (OSI) stack. For example, the security protocols may operate at the media access control (MAC) layer, the network layer, the application layer, or the like. In accordance with an example embodiment, various types of security protocols are implemented and used for various purposes such as, for example, device authentication, user authentication, biometric authentication, session key generation for protecting integrity or confidentiality of messaging and data, message authentication, perfect forward secrecy (PFS), generation of temporary identities, or the like. Security protocols that may be facilitated by the cryptographic architecture 106 include, for example and without limitation, diffie-hellman (DH) key exchange protocols, extensible authentication protocols (EAPs) (e.g., EAP-SIM/AKA, EAP-TLS, EAP-TTLS), generic bootstrapping architecture (GBA) for application layer bootstrapping in 3G/4G networks, IPSec for protecting IP layer traffic, and WiFi 4-way. The EAP methods may be used for hotspot access and may operate at the MAC layer.

In accordance with the illustrated embodiment, the cryptographic function modules 304 implement various cryptographic functions within the cryptographic architecture 106. Example cryptographic functions that may be implemented include, without limitation, encryption/decryption functions with symmetric keys, encryption/decryption functions with asymmetric keys, block ciphers, stream ciphers, hashing functions, functions that generate digital signatures, functions that generate public/private key pairs, or the like. Example encryption/decryption functions with symmetric keys include, without limitation, Triple Data Encryption Standard (Triple-DES) algorithms, advanced encryption standard (AES) functions, or the like. Example encryption/decryption functions with asymmetric keys include, without limitation, RSA functions, the Elliptic-Curve Integrated Encryption scheme (ECIES), or the like. Example hashing functions include, without limitation, SHA functions, HMAC-SHA functions with different key lengths, MD5 functions, Elliptic Curve Digital Signature Algorithm (ECDSA) or the like. The supplementary function module 308 implements supplementary functions such as, for example, functions that derive public/private key pairs and random number generator (RNG) functions. A Pseudo-Random Function (PRF) may be used to invoke hash functions, for example, in order to generate specific keys. The PRF (e.g., TLS PRF) may be implemented independently as a separate cryptographic function module 304. Alternatively, the PRF may be implemented within the cryptographic framework module 302, which may be used to call other cryptographic functions such as HMAC-SHA or MD5 based cryptographic functions.

In accordance with the illustrated embodiment, the cryptographic framework module 302 is invoked by the security modules 104 via the cryptographic API. For example, the cryptographic framework module 302 may be invoked by requesting specific cryptographic functions or by providing certain characteristics of a cryptographic function. Such characteristics may then be used by the cryptographic framework module 302 to select a particular cryptographic function module 304 optionally with the aid of the Supplementary function module 308. Example parameters and API calls are described below, although embodiments are not limited to the example parameters and API calls.

Various parameters may be used by the security modules 104 and the cryptographic framework module 302 to invoke a cryptographic function module 304, and in particular a cryptographic function. Parameters may include, for example, a security method (protocol) type (SMT), a cryptographic function (CF), a master key (MK), a context identity (ContextId), a string, a cryptographic result (CR), a characteristic of a cryptographic function (Char), and a supplementary request (SR). For example, the SMT may refer to a unique identity for each of the security protocols that are registered within the UE 301 and cryptographic framework module 302. Using the cryptographic function parameter, the security modules may request a particular cryptographic function or multiple cryptographic functions such as, for example AES, Triple-DES, SHA, MD5, or the like. Such a request may comprise a code or index indicating the specific cryptographic function module 304, and in particular the specific cryptographic function, that the security module 104 desires or that may be selected by the cryptographic framework module 302. By way of example, an index of 1 may correspond to SHA-1, an index of 2 may correspond to SHA-256, and an index of 3 may correspond to AES-256. It will be understood that cryptographic function parameters or indices may be assigned to any cryptographic functions or supplementary functions as desired. It will further be understood that a Pseudo-Random Function (PRF) module may be implemented as an independent cryptographic function module 304 or might reside within the cryptographic framework module 302 and thus the PRF module may use one or more of the cryptographic function modules 304 to perform cryptographic operations such as derivation or computation of specific keys.

In accordance with an example embodiment, a master key parameter includes a key that may be provided by one of the security modules 104 or may be derived and/or stored in the key vault 306. Such a key may be used by a cryptographic function module 304 to derive a cryptographic result. The master key may be a password, passphrase, or the like. In another embodiment, the master key is a public key that is associated with the application 102 or the security module 104. The context ID parameter may identify the association between one of the applications 102 and one of the security modules 104. For example, the context ID parameters may be used by the cryptographic framework module 302 to create a mapping between the calling (requesting) security module 104, a master key (MK), and the context of the association. The context ID may enable cryptographic framework module 302 to index master keys within the key vault 306. For example, multiple security protocols 104 may share a common context ID. In an example embodiment, if the security modules 104 are able to provide the appropriate context ID to the cryptographic framework module 302, keys that are used by a first one of the security modules 104 and that are derived from one of the cryptographic function modules 304 or the supplementary function module 308, may be used by other security modules 104 that are different than the first security module 104. The security modules 104 may further provide a string parameter to the cryptographic framework module 302. Alternatively, the cryptographic framework module 302 may create a string, for example, based on the context of the association. For example, a value of the string parameter in EAP-AKA may comprise, “EAP-AKA”|Identity, where “Identity” refers to the identity (Id) of the UE 301. The string “EAP-AKA” and the Identity parameter may be concatenated in a certain manner as specified by the EAP-AKA standard or the like.

In accordance with the illustrated embodiment, the cryptographic result (CR) parameter refers to the final result of one or more operations that are performed by one or more of the cryptographic function modules 304. The cryptographic result may be provided by the cryptographic framework module 302 to the calling security module 104. The CR may refer to, but is not limited to: 2G/3G cryptographic results (e.g., RES (Authentication Result), Cipher Key (CK), Integrity Key (IK), etc.); GBA results (e.g., Ks NAF such as Ks_int_NAF and Ks_ext_NAF), CK|IK (Ks), RES, etc.); EAP keys (e.g., Master Session Key (MSK), Extended MSK (EMSK), K_aut, K_re, K_enc, etc.); EAP-RP keys (e.g., Re-authentication Integrity Key (rIK), Re-auth Root Key (rRK), Re-auth Master Session Key (rMSK); 802.11i results (e.g., Pairwise Transient Keys (PTK), which comprise KCK, KEK, TEK); and IPSec Keys (e.g., KEYMAT for both directions). Thus, the cryptographic result may include at least one of a cipher key, an integrity key, a generic bootstrapping architecture (GBA) key, an extensible authentication protocol (EAP) key, an EAP reauthentication protocol (EAP-RP) key, a pairwise transient key, a public/private key pair, an 802.11 pair-wise transient keys, IPSec Keymat, an internet protocol security key, an OpenID shared secret, or an OpenID key. The cryptographic results may be the results of protocols used to secure higher-layer applications such as TLS/SSL (e.g., TLS master secret) for example.

In accordance with an example embodiment, parameters that invoke cryptographic functions may include one or more characteristics of the cryptographic function that is to be invoked. For example, in some scenarios the security modules 104 may not indicate a specific cryptographic function that is to be used. In such a scenario, the requesting security module 104 may indicate various characteristics of the desired cryptographic function, and thus the desired cryptographic function module 304, such as a type or cryptographic strength of a function that it desires to be selected for example. Thus, the requesting security module 104 may allow the cryptographic framework module 302 to select the cryptographic function module 304, and in particular the cryptographic function that is to be executed. For example, based on one or more characteristics that the cryptographic framework module 302 receives from the security modules 104, the cryptographic framework module 302 may select and invoke the appropriate cryptographic function module 304. The characteristic may refer to the desired strength of a security algorithm or to the type (T) of the cryptographic function that is desired by the security module 104. Types may correspond to function categories such as, for example, encryption, hashing, digital signatures, or the like. By way of example, a type 1 may indicate that an encryption function is requested, a type 2 may indicate that a hashing function is requested, a type 3 may indicate that a key derivation is requested, and a type 4 may indicate that a signature generation is requested. It will be understood that types may correspond to different functions as desired. By way of further example, a characteristic for strength (S) may be associated with each of the cryptographic function modules 304. Example strength characteristics include, without limitation, strong, medium, weak, high randomness, low randomness, or the like. Example characteristics further include, a speed (Sp) of running a function (e.g., fast, medium, slow); a number of iterations (e.g., the number of times that one of the cryptographic function modules 304 may have to be called); a length (L) (e.g., Key Length); and an order of key selection (O). For example, the order of key selection characteristic may specify the first ‘n’ bits or the last ‘n’ bits of a desired key.

To illustrate subsets of characteristics by way of example, a select one of the security modules 104 may request that a type ‘1’ function be performed, which may correspond to any function that is categorized as an encryption function. The security module 104 may further request, via the strength characteristic, that the desired strength of the encryption is strong or medium. In an example embodiment, a ‘strong’ encryption algorithm is at least 128 bits (e.g., AES 128/192/256), and an encryption/decryption function that has at least a ‘medium’ strength is at least 80 bits (e.g., Triple-DES, SKIPJACK). Further differentiation may be introduced by incorporating information about the type of encryption (e.g., Asymmetric vs. Symmetric algorithms). In another example embodiment, strong algorithms may be classified as ‘strong asymmetric’ or ‘strong symmetric’ algorithms. Thus, in response to the request from the select one security module 104 specifying a desired cryptographic type and a desired cryptographic strength required to perform the security method implemented by that security module 104, the cryptographic framework module 302 may automatically invoke a select one of the cryptographic function modules 304 iteratively, as required, to provide the requested cryptographic type and strength.

By way of another example, a select one of the security modules 104 may request that a type ‘2’ function be performed, which may correspond to any function that is categorized as a hashing function. The select security module 104 may further request, via the strength characteristic, that the desired strength of the hashing is very strong, strong, or medium. In an example embodiment, a ‘very strong’ hashing algorithm includes SHA-3 (Keccak) with digest output bits that are at least 224 bits, a ‘strong’ hashing algorithm is at least 112 bits (e.g., SHA-2: 256/384/512) and uses a strong cryptographic engine such as SHA-2 (e.g., weaker than SHA-3), and a hashing function that has at least a ‘medium’ strength is at least 80 bits (e.g., SHA-1) with a medium cryptographic engine (e.g., weaker than SHA-2 and SHA-3). By way of yet another example, a select one of the security modules 104 may request that a type ‘3’ function be performed, which may correspond to any function that is categorized as a key derivation function. The key derivation function may be based on a password based key derivation function (e.g., PBKDF1 or PBKDF2) algorithm or based on other key based algorithms such as, for example, an HMAC-based extract and expand key derivation function (HKDF). The select security module 104 may further request, via the strength characteristic, that the desired strength of the key derivation has a high key randomness (e.g., HMAC-SHA-256/384/512) or a low key randomness (e.g., CRC). In response to the requests from the security modules 104 specifying a desired cryptographic type and a desired cryptographic strength required to perform the security method implemented by that security module 104, the cryptographic framework module 302 may automatically invoke the cryptographic function modules 304 iteratively, as required, to provide the requested cryptographic type and strength. It will be understood that cryptographic types with the associated index values (e.g., 1, 2, 3) presented above are merely for purposes of example, and thus values may be assigned to other types of cryptographic functions such as, for example, Digital Signature functions, Random Number Generation functions, or the like.

The supplementary request (SR) parameter may comprise information represented as bits and/or bytes. The SR parameter may specify that a supplementary cryptographic function is to be performed. Example supplementary cryptographic functions include, without limitation, random number generating functions (e.g., nonces, salt, TLS premaster secret, Diffie-Hellman secret number generator, etc.) or functions for generating private/public key pairs that may be used for Diffie-Hellmman, RSA, Identity Based Encryption, providing Perfect-Forward-Secrecy (PFS), or other like protocols. Further, the SR parameter may include information for instructing the cryptographic framework module 302 to obtain a key from the key vault 306. In response to a request from a select one security modules 104 specifying a desired supplementary cryptographic result, the cryptographic framework module 302 may automatically invoke a select supplementary function module 308 iteratively, as required, to provide the requested result.

With continuing reference to FIGS. 1-3, in accordance with the illustrated embodiment, various types of API calls may be processed by the cryptographic framework module 304. Examples of types of API calls are described below, although it will be understood that API calls are not limited to the following examples and may vary as desired. The calls may include parameters such as the parameters dsecribed above. By way of example, a request call “GetCryptoValuesReq(ContextId, SMT, CF/Char, MK, String, SR*)” may be sent by the security modules 104 to the cryptographic framework module 302 to generate a desired cryptographic result (CR). As shown, the example request call includes parameters such as a context identity (Context ID), a security method type (SMT), a desired cryptographic function (CF) or desired characteristics (Char) of a cryptographic function, a master key, and a string. As shown, the example request call may further include a supplemental request (SR) parameter (denoted with an asterik to indicate that the SR is optional in this example). Thus, the requested cryptographic result is associated with at least one parameter.

Based on the request, an example response call “GetCryptoValuesResp(ContextId, CF, CR, PublicKey*, RAND/Nonce*)” may be sent by the cryptographic framework module 302 to the requesting security module 104. The example response call includes the context identity, an identity of the invoked crytpgraphic fuction, and the requested cryptographic result. Thus, based on at least one of the received parameters, the cryptographic function is selected that satisfies the request. The response call may further include supplemental parameters if, for example, the request call included a supplemental request. For example, based on a supplemental request parameter, the response call may include a public key or random number/nonce.

By way of further example, the ContextId may be used by the framework module 302 to obtain an existing key (e.g., a master key, shared secret, etc.) or security context from the key vault 306, and to obtain policies or processes associated with that context that are available. Such a response may return the cryptographic result and information indicative of the cryptographic function used and strength achieved to the requesting security module 104. The example request call “GetCryptoResultReq(MK, RAND/Nonce*, String)” may be sent by the cryptographic framework module 302 to automatically invoke a select one of the cryptographic function modules 304 iteratively, as required, to provide the requested cryptographic result. The example call “GetCryptoResultResp(CryptoResult)” may be used by the cryptographic function modules 304 to execute one or more cryptographic functions to compute the requested cryptographic result and send it to the cryptographic framework module 302.

While other example call flows are presented below, it will be understood that API calls are not limited to the following examples and API call flows may vary as desired in accordance with various embodiments. The example call “GetMasterKeyReq(ContextId)” may be sent by the cryptographic framework module 302 to the key vault 306 so that a master key can be retrieved by using the context ID. The example call “GetMasterKeyResp(MK)” may be used by the key vault 306 to send the requested master key (MK) to the cryptographic framework module 302. The example call “GetRandomValuesReq(type of Random Values requested)” may a list or array of random values such as, for example, RAND/Nonce values, salt or public/private Keys that are requested from the supplementary function modules 308 by the cryptographic framework module 302. Such a call may include a request for multiple random values at one time and the list may be represented using bits/bytes of data with sizes of the random values that are requested. The supplementary functions may be implemented separately by separate supplementary function modules 308 or they be implemented together by one supplementary function module 308. The example call “GetRandomValuesResp(RAND/salt/Nonce*, Public/Private Key pair*)” may be sent by the cryptographic framework module 302 to the supplementary function modules 308 so that the supplementary function modules 308 return a RAND or a Nonce, salt, Public/Private Key pair, or a combination of thereof, to the cryptographic framework module 302. The example call “SetKeyinVault(ContextId, Key)” may be invoked by the cryptographic framework module 302 to store a key in the key vault 306. The key that is stored may have been derived using the cryptographic function modules 304 that each execute one or more cryptographic functions or the supplementary function modules 308 that may execute random number generation functions or public/private key generation functions. Alternatively, the framework module 302 may be used by the security modules 104 to store pre-shared keys within the vault 306.

In accordance with an example embodiment, the cryptographic framework module 302 is responsible for processing API calls from the security modules 104 and invoking the appropriate cryptographic function module 304, and thus the appropriate cryptographic function. In an example implementation of the cryptographic framework module 302 and the security modules 104, the security modules 104 provide a master key and a string within their API calls. Alternatively, the security modules 104 may provide a context id that may be used to obtain a master key from the key vault 306. Such calls that include the master key and string parameters are used by the cryptographic framework module 302 to invoke the appropriate cryptographic function modules 304.

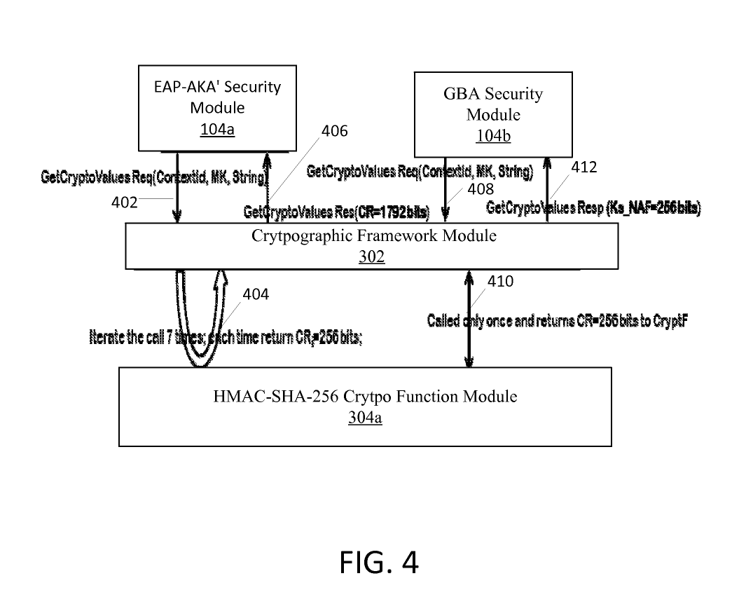

FIG. 4 is a flow diagram that illustrates the cryptographic framework module 302 implementing a Generic Bootstrapping Architecture (GBA) protocol and an Extensible Authentication Protocol (EAP) that use the same cryptographic function (CF) in accordance with an example embodiment. In accordance with the illustrated embodiment, an EAP-AKA′ security module 104a and a GBA security module 104b use the cryptographic framework module 302 to use a common HMAC-SHA-226 cryptographic function module 304a to derive session keys. In accordance with the illustrated embodiment, at 402, the EAP-AKA′ security module 104a sends a context identity, a master key associated with the context identity, and an associated string to the cryptographic framework module 302. In response, a policy on the cryptographic framework module 302 may direct the cryptographic framework module 302 to invoke the HMAC-SHA-256 cryptographic function module 304a and iterate it seven times in order to generate 1792 bits. At 404, the cryptographic framework module 302 invokes the cryptographic function module 304a iteratively (e.g., seven times) to deliver the requested cryptographic result to the security module 104a (at 406).

With continuing reference to the example embodiment depicted in FIG. 4, at 408, a GBA security module 104b invokes an appropriate API call by sending a ContextId, a master key, and an associated GBA defined string to the cryptographic framework module 302. An operating policy on the cryptographic framework module 302 may direct the cryptographic framework module 302 to invoke the HMAC-SHA-256 cryptographic function module 304a and provide the cryptographic function module 304a with the appropriate parameters. In accordance with the illustrated embodiment, the cryptographic function module 304a is invoked once, at 410, to return a Ks_NAF having 256 bits. At 412, the cryptographic framework module 302 returns the requested cryptographic result, in particular the Ks_NAF, to the GBA security module 104b. In an example embodiment in which there is a requirement for generating both Ks_int_NAF and Ks_ext_NAF, two iterations of the HMAC-SHA 256 cryptographic function may be performed.

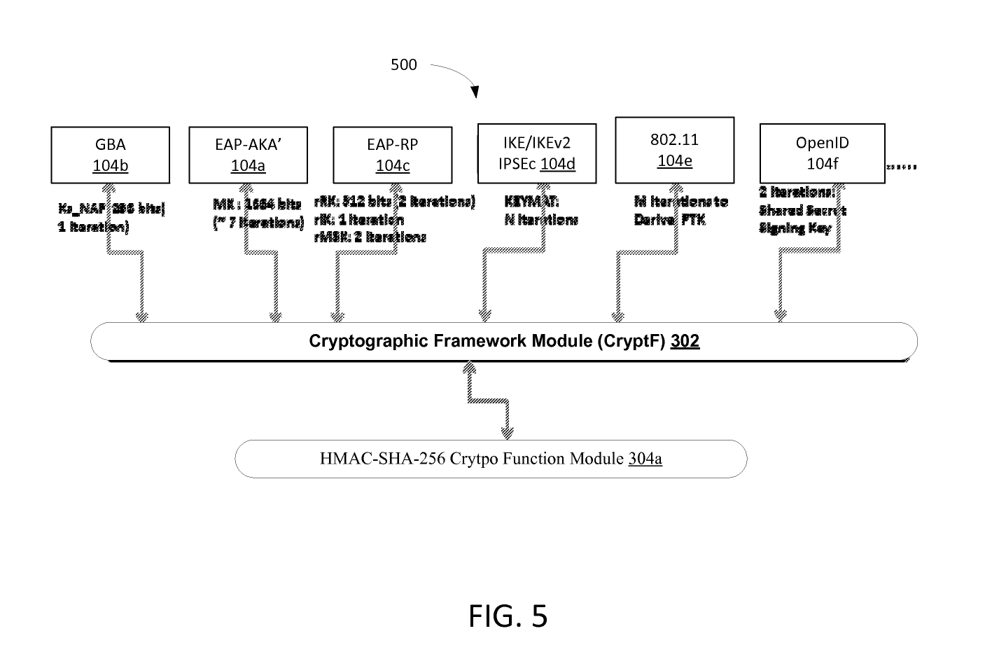

FIG. 5 is a block diagram of a portion of a UE 500 that includes various security modules 104 that are capable of interworking with the cryptographic framework module 302 in accordance with an example embodiment. In accordance with the illustrated embodiment, a plurality of security modules 104 are each capable of implementing a different security method for authenticating the UE 500 with a network. The plurality of security modules 104 includes the GBA security module 104b, the EAP-AKA′ security module 104a, an EAP-RP security module 104c, an IKE/IKEv2/IPSec security module 104d, an 802.11i security module 104e, and an OpenID/OpenID Connect security module 104f. It will be understood that the UE 500 may include additional or alternative security modules as desired. In some instances, different security modules 104a-f may share the same context ID and thus may be able to use the same master key. Such security modules may be associated with a different string from each other. In an example embodiment in which there was a prior association between the security module 104 and the cryptographic framework module 302, a context ID that that identifies the application/session that had invoked the security module 104 is transferred by the security protocol 104 to the cryptographic framework module 302. The cryptographic framework module 302 may then prepare the string that may be required as input to the appropriate cryptographic function module 304 or the cryptographic framework module 304 may use the string that is provided to it by the security module 104.

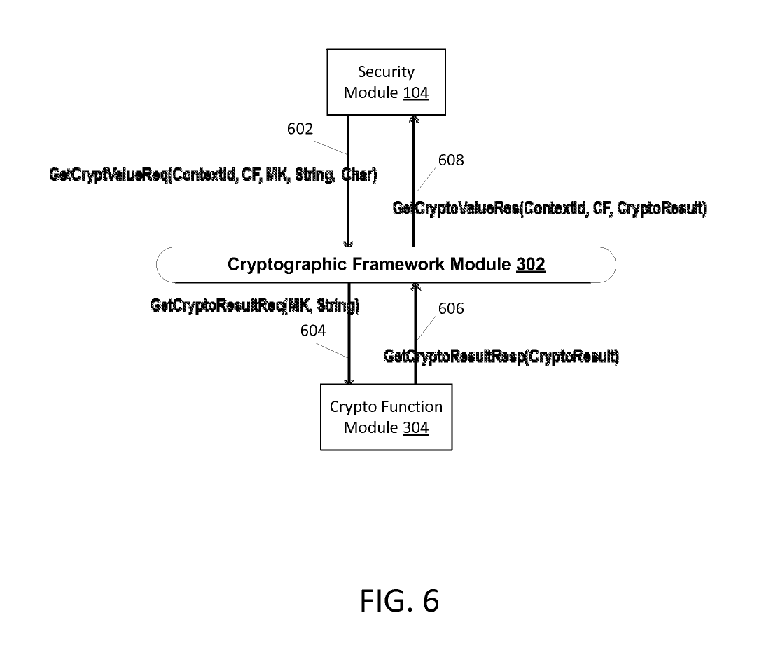

FIG. 6 is a flow diagram illustrating the cryptographic framework module 302 using various API calls to implement a security method and a cryptographic function in accordance with an example embodiment. Referring to the illustrated embodiment of FIG. 6, API calls are communicated between one of the security modules 104, the cryptographic framework module 302, and one of the cryptographic function modules 304. At 602, the security module 104 requests a cryptographic result by generating a call, GetCryptResultReq( ) that comprises a context ID, a specific cryptographic function, the master key associated with the context ID, a string associated with the context. The call may further include one or more characteristics of the desired cryptographic function. At 604, upon receiving the request from the security module 104, the cryptographic framework module 302 may invoke the specific cryptographic function module 304 based on the requested cryptographic function. If a cryptographic function is not explicitly requested by the security module 104, for example, the cryptographic framework module 302 may invoke an appropriate cryptographic function module based on the one or more characteristics. At 604, the master key and the string may be provided by the cryptographic framework module 302 to the cryptographic function module 304. At 606, the cryptographic function module 304 computes the cryptographic result (CR) using the MK and string, and sends the CR to the cryptographic framework module 302 using the call GetCryptoResultRespQ. At 608, the cryptographic framework module 302 sends the cryptographic result with the context ID and the identity of the cryptographic function that was used for computing the CR, to the requesting security module 104.

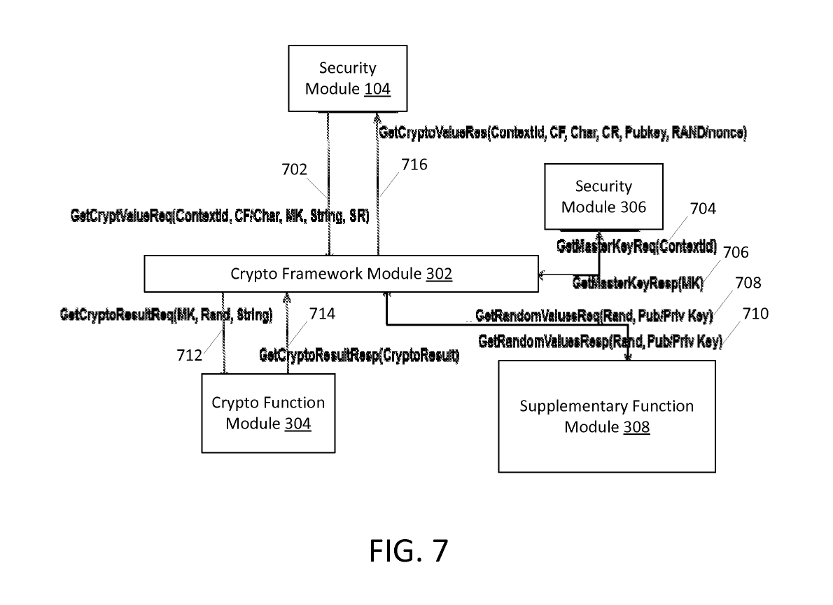

Referring to the illustrated embodiment shown in FIG. 7, the cryptographic framework module 302 may invoke the services of the supplementary function module 308 to execute supplementary cryptographic functions such as, for example, a Pseudo-Random Number Generator Function or a Public/Private Key pair Generator Function. In an example embodiment, the cryptographic framework module 302 may fetch a master key (MK) from the key vault 306, for example if the MK has not been provided within the API call, using a Context ID provided by one of the security modules 104.

With continuing reference to FIG. 7, at 702, one of the security modules 104 may make a request to get a cryptographic result, via an API call such as GetCryptResultReq( ). The request may comprise a Context ID, a specific cryptographic function, the master key associated with the Context ID, a string associated with the context, and/or characteristics (Char) of the cryptographic function. The request may further include one or more supplementary requests (SR). For example, the SR may comprise information that requests that the cryptographic framework module 302 use a master key from the key vault 306. The SR may further request the generation of public/private key pairs (e.g., for PFS). At 704, upon receiving the request from the security module 104 and inspecting the SR that directs the cryptographic framework module 302 to obtain a master key from the key vault 306, the cryptographic function module 302 sends a call, GetMasterKeyReq( ), with the Context ID to the key vault 306. At 706, using the Context ID, the key vault 306 returns a master key or keys, for example, using a call such as GetMasterKeyResp( ). At 708, since the SR may have further included information requesting the generation of a public/private key pair, the cryptographic framework module 302 may send a call, GetRandomValuesReq( ), that indicates the desire for the supplementary function module 308 to generate the public/private Key pair. At 710, the supplementary function module 308 generates a RAND/Nonce/salt and/or a public/private key pair, and sends the information to the cryptographic framework module 302 using a call such as GetRandomValuesResp( )for example. At 712, based on the request from the security module 104, the cryptographic framework module 302 invokes the appropriate cryptographic function module 304, and in particular the specific cryptographic function requested by the security module 104. If a specific cryptographic function is not requested by the security module 104, then the cryptographic framework module 302, based on the one or more characteristics for example, invokes the appropriate cryptographic function module 304 to execute the appropriate cryptographic function. Security characteristics may indicate the type of cryptographic function (e.g., message authentication, encryption, session key generation functions, etc.) At 712, the MK, string, and RAND/nonce may be provided by the cryptographic framework module 302 to the cryptographic function module 304. At 714, the cryptographic function module 304 executes the cryptographic function to compute the cryptographic result (CR) using the MK, String and/or RAND/Nonce/salt/private/public keys. The cryptographic function module 304 sends the CR to the cryptographic framework module 302 using the GetCryptoResultResp( )call. At 716, the cryptographic framework module 302 returns the CR, the context ID, the identity of the cryptographic function that was used for computing the CR, and the public key to the requesting security module 104.

In one example embodiment, an authentication server or other network entity that is part of a network with which a UE is to be authenticated, conveys, to the UE, one or more characteristics of the type of cryptographic function to be used. In particular, the network may convey the characteristics of a desired cryptographic function such that the security modules 104 or the cryptographic framework module 302 can select an appropriate cryptographic function having the requested characteristics. The appropriate cryptographic function may at least meet criteria as indicated by values of the one more characteristics. Further, the security modules 104 may convey, to the authentication server or the other entities with which the UE establishes secure communications, the cryptographic function that was used to generate the cryptographic result such as cryptographic keying material for example. In accordance with one embodiment, the security modules 104 convey the identity of the cryptographic function to the network server during scenarios in which the cryptographic framework module 302 selected the cryptographic function on behalf of the security module 104 and/or applications, such as the applications 102 shown in FIG. 1.

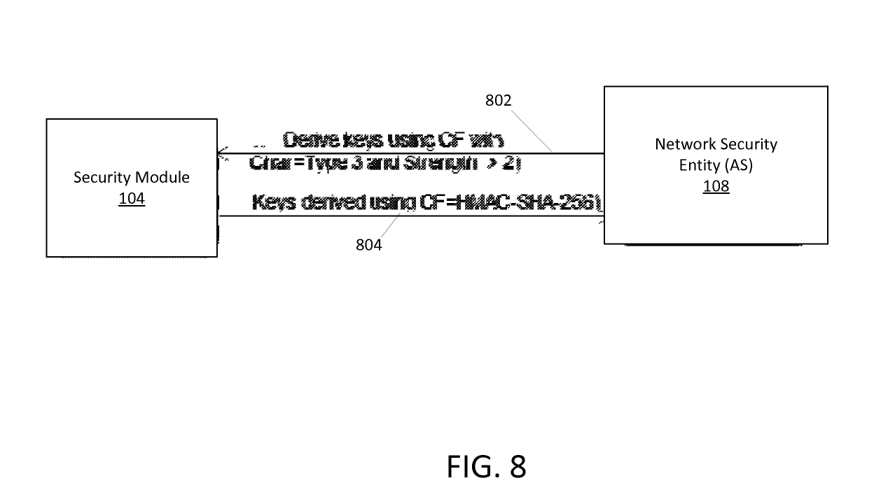

Various security protocol messages may carry cryptographic information. In accordance with an example embodiment, the implementation of security protocol messages (e.g., EAP, IKE, GBA, etc.) includes information indicating the respective characteristics of each security protocol. A security protocol message may further include the identity of cryptographic functions that were executed to implement the security protocol. FIG. 8 is a flow diagram illustrating security protocol messages according to an example embodiment, wherein the messages comprise cryptographic information and the messages are exchanged between the network security entity 108, which may be also referred to as an authentication server (AS) 108, and one of the security modules 104. In accordance with the illustrated embodiment, at 802, the AS 108 requests that the security module 104 derive keys, for example, using a key derivation function (KDF) (e.g., type ‘3’) having a strength greater than ‘2’. Based on the request, the cryptographic framework module 302 may make a decision that the HMAC-SHA-256 function is the appropriate KDF and may derive keys using the same that matches the strength requested by the AS 108. This decision information may be conveyed by the cryptographic framework 302 to the security module 104 using an appropriate API call, which may then be conveyed to the AS 108 from the security module 104, at 804.

In accordance with another example embodiment, a cryptographic function (CF) that is used for key generation (e.g., KDF or PRF) may be used to obtain characteristics of a different CF. By way of an example, the HMAC-SHA-256 cryptographic function may be run twice to obtain a 512 bit key comprising similar characteristics as a HMAC-SHA-512 key. By way of further example, an HMAC-SHA-512 cryptographic function may be run once to obtain two 256-bit keys. Such operations may be completed while ensuring that the overall security strength of the KDF or PRF is not reduced in accordance with an example embodiment.

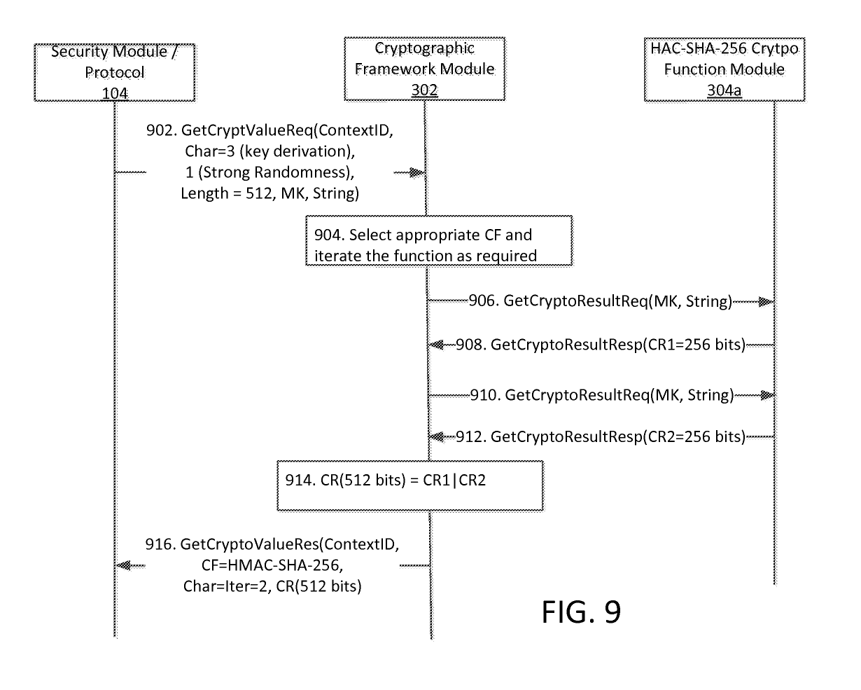

FIG. 9 is a flow diagram that illustrates the cryptographic framework module 302 invoking a multiple output cryptographic function according to an example embodiment. In accordance with the illustrated embodiment, the HMAC-SHA-256 cryptographic function module 304a generates keys of varying lengths using a Pseudo-Random-Function (PRF). For example, the PRF may be implemented within the cryptographic module 312 or may be implemented as an independent cryptographic function module 304. Referring to FIG. 9, at 902, the security module 104 sends a request, to the cryptographic framework module 302, for the computation of a cryptographic result. In accordance with the illustrated embodiment, the request includes a Context ID, a string associated with the requesting security protocol, and characteristic values that indicates a requirement for a “Key Derivation” function having Strong Randomness properties and a key length that is equal to 512. At 904, based on the received characteristics, an appropriate cryptographic function module (e.g., the HMAC-SHA-256 cryptographic function module 304a), and thus an appropriate cryptographic function, is selected by the cryptographic framework module 302. For example, in accordance with the illustrated embodiment, the cryptographic framework module 302 determines that the HMAC-SHA-256 cryptographic function module 304a outputs 256 bits, and therefore the cryptographic framework module 302 invokes the HMAC-SHA-256 cryptographic function module 304a iteratively, and in particular in two iterations, to produce a 512 bit key. Thus, the cryptographic framework module may determine a number of iterations for invoking a select one cryptographic function module to return the requested cryptographic type and strength.

With continuing reference to FIG. 9, at 906, the cryptographic framework module 302 invokes the HMAC-SHA-256 cryptographic function module 304a, and in particular the HMAC-SHA-256 algorithm, that can be used for key derivation, and which can produce the requested strong randomness and an 256 bit output. The cryptographic framework module 302 may provide the string and the MK to the HMAC-SHA-256 cryptographic function module 304a at 906. At 908, the HMAC-SHA-256 cryptographic function module 304a uses the MK and the received string to compute a first crypto result (CR1), which is 256 bits long. The HMAC-SHA-256 cryptographic function module 304a sends the CR1 to the security module 104. In accordance with the illustrated embodiment, at 910, the HMAC-SHA-256 cryptographic function module 304a is invoked again, for example, using the same call and the same MK, or alternatively, the CR1 may be mixed with MK and provided at 906, but using a different “string” value than previously used. The string value is based on the security module 104, and in particular the security protocol that is implemented by the security module 104. At 912, the CF computes a second cryptographic result (CR2), which is 256 bits long in accordance with the illustrated embodiment. The CR2 is sent to the cryptographic framework module 302. At 914, the cryptographic framework module 302 concatenates the CR1 with the CR2 to produce a 512 bit CR. At 916, the cryptographic framework module 302 sends the 512 bit cryptographic result, along with information indicative of the cryptographic function that was used (e.g., HMAC-SHA-256) and the number of iterations that was carried out (e.g., 2), to the security module 104.

By way of another example, a request may be received for a CR having characteristics of a key derivation type, a strength of Strong Randomness, and a length of 128 bits. In response to such a request, if the HMAC-SHA-256 cryptographic function is implemented, the cryptographic framework module 302 may invoke the HMAC-SHA-256 cryptographic function module 304a to meet the criteria of the request. Thus, 128 bits should be sent to the requesting security module 104 to satisfy the request. The sent bits may be the first or the last 128 bits of the 256 bits, for example. An indication may be sent using the order of selection (O) characteristic, which may indicate which bits were selected. For example, if the order selected is 1 then the first 128 bits may be used. By way of further example, if the order selected is not 1 then the last 128 bits may be selected. The security module 104 communicates the order (O) to the network security entity 108 in accordance with an example embodiment. For example, the AS 108 may request the order via the security module 104. The order of selection may be determined by the cryptographic framework module 302 in accordance with another example embodiment.

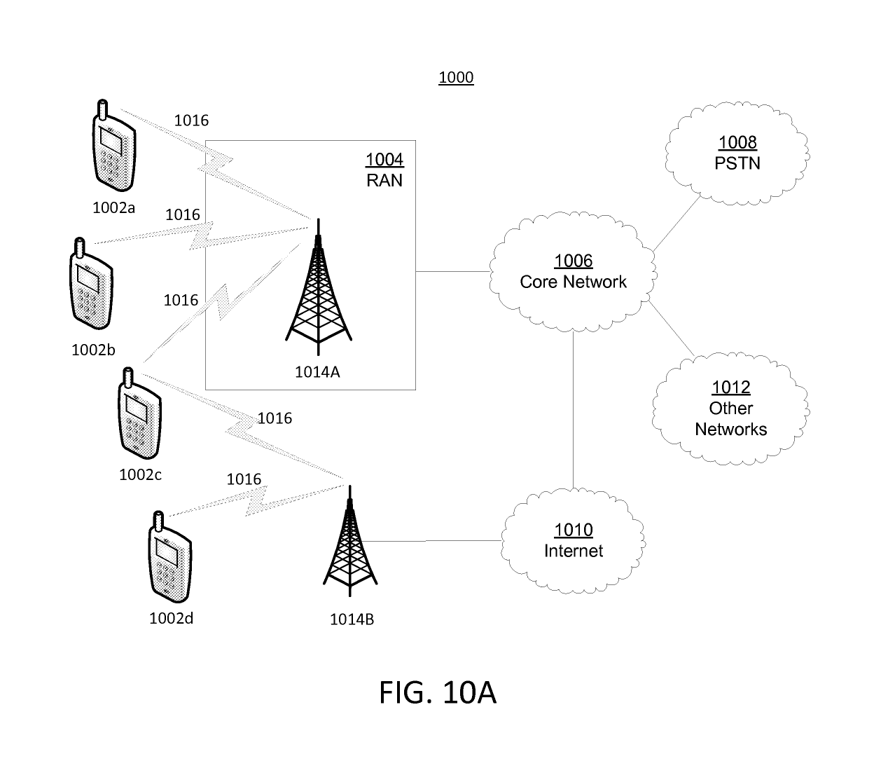

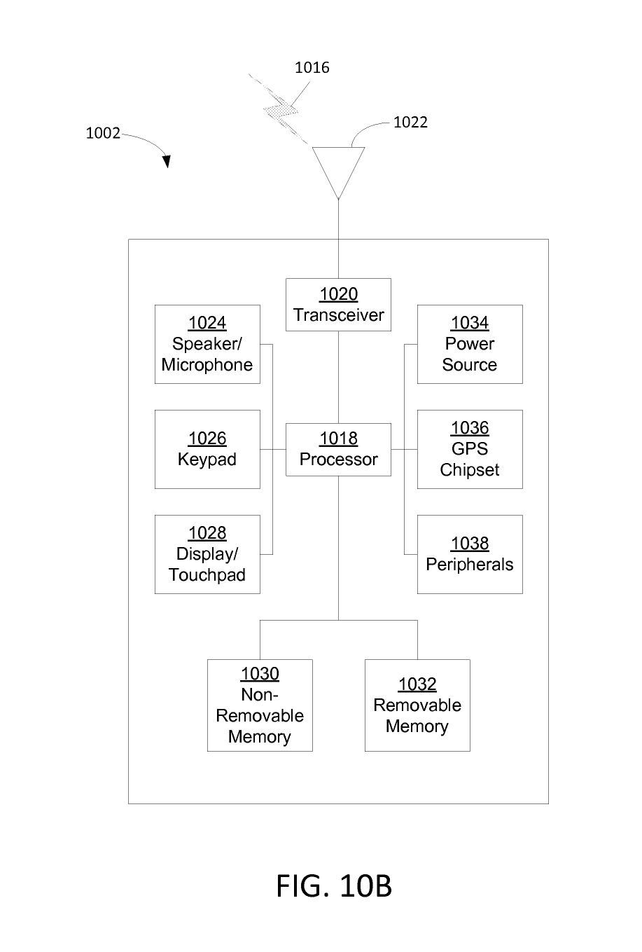

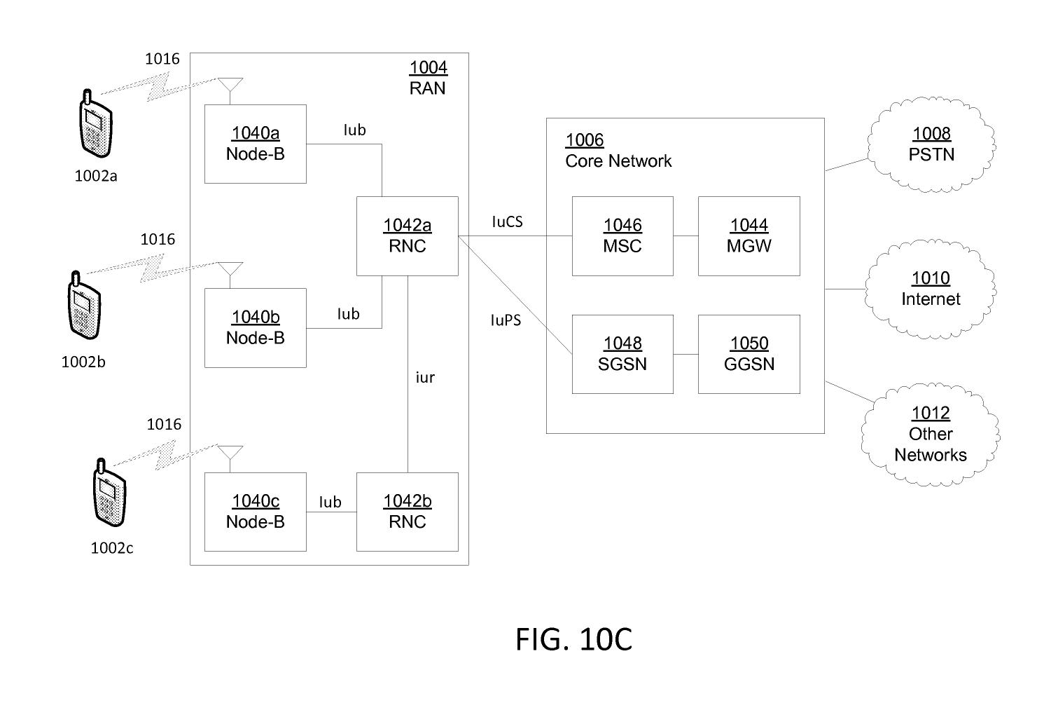

FIG. 10A is a diagram of an example communications system 1000 in which one or more disclosed embodiments may be implemented. The communications system 1000 may be a multiple access system that provides content, such as voice, data, video, messaging, broadcast, etc., to multiple wireless users. The communications system 1000 may enable multiple wireless users to access such content through the sharing of system resources, including wireless bandwidth. For example, the communications systems 1000 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 10A, the communications system 1000 may include wireless transmit/receive units (WTRUs) 1002a, 1002b, 1002c, 1002d, a radio access network (RAN) 1004, a core network 1006, a public switched telephone network (PSTN) 1008, the Internet 1010, and other networks 1012, though it will be appreciated that the disclosed embodiments contemplate any number of WTRUs, base stations, networks, and/or network elements. Each of the WTRUs 1002a, 1002b, 1002c, 1002d may be any type of device configured to operate and/or communicate in a wireless environment. By way of example, the WTRUs 1002a, 1002b, 1002c, 1002d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 1000 may also include a base station 1014a and a base station 1014b. Each of the base stations 1014a, 1014b may be any type of device configured to wirelessly interface with at least one of the WTRUs 1002a, 1002b, 1002c, 1002d to facilitate access to one or more communication networks, such as the core network 1006, the Internet 1010, and/or the networks 1012. By way of example, the base stations 1014a, 1014b may be a base transceiver station (BTS), a Node-B, an eNode B, a Home Node B, a Home eNode B, a site controller, an access point (AP), a wireless router, and the like. While the base stations 1014a, 1014b are each depicted as a single element, it will be appreciated that the base stations 1014a, 1014b may include any number of interconnected base stations and/or network elements.

The base station 1014a may be part of the RAN 1004, which may also include other base stations and/or network elements (not shown), such as a base station controller (BSC), a radio network controller (RNC), relay nodes, etc. The base station 1014a and/or the base station 1014b may be configured to transmit and/or receive wireless signals within a particular geographic region, which may be referred to as a cell (not shown). The cell may further be divided into cell sectors. For example, the cell associated with the base station 1014a may be divided into three sectors. Thus, in an embodiment, the base station 1014a may include three transceivers, i.e., one for each sector of the cell. In an embodiment, the base station 1014a may employ multiple-input multiple output (MIMO) technology and, therefore, may utilize multiple transceivers for each sector of the cell.

The base stations 1014a, 1014b may communicate with one or more of the WTRUs 1002a, 1002b, 1002c, 1002d over an air interface 1016, which may be any suitable wireless communication link (e.g., radio frequency (RF), microwave, infrared (IR), ultraviolet (UV), visible light, etc.). The air interface 1016 may be established using any suitable radio access technology (RAT).

More specifically, as noted above, the communications system 1000 may be a multiple access system and may employ one or more channel access schemes, such as CDMA, TDMA, FDMA, OFDMA, SC-FDMA, and the like. For example, the base station 1014a in the RAN 1004 and the WTRUs 1002a, 1002b, 1002c may implement a radio technology such as Universal Mobile Telecommunications System (UMTS) Terrestrial Radio Access (UTRA), which may establish the air interface 1016 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 1014a and the WTRUs 1002a, 1002b, 1002c may implement a radio technology such as Evolved UMTS Terrestrial Radio Access (E-UTRA), which may establish the air interface 1016 using Long Term Evolution (LTE) and/or LTE-Advanced (LTE-A).

In other embodiments, the base station 1014a and the WTRUs 1002a, 1002b, 1002c may implement radio technologies such as IEEE 1002.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 1014b in FIG. 10A may be a wireless router, Home Node B, Home eNode B, femto cell base station, or access point, for example, and may utilize any suitable RAT for facilitating wireless connectivity in a localized area, such as a place of business, a home, a vehicle, a campus, and the like. In an embodiment, the base station 1014b and the WTRUs 1002c, 1002d may implement a radio technology such as IEEE 802.11 to establish a wireless local area network (WLAN). In an embodiment, the base station 1014b and the WTRUs 1002c, 1002d may implement a radio technology such as IEEE 802.15 to establish a wireless personal area network (WPAN). In yet an embodiment, the base station 1014b and the WTRUs 1002c, 1002d may utilize a cellular-based RAT (e.g., WCDMA, CDMA2000, GSM, LTE, LTE-A, etc.) to establish a picocell or femtocell. As shown in FIG. 10A, the base station 1014b may have a direct connection to the Internet 1010. Thus, the base station 1014b may not be required to access the Internet 1010 via the core network 1006.

The RAN 1004 may be in communication with the core network 1006, which may be any type of network configured to provide voice, data, applications, and/or voice over internet protocol (VoIP) services to one or more of the WTRUs 1002a, 1002b, 1002c, 1002d. For example, the core network 1006 may provide call control, billing services, mobile location-based services, pre-paid calling, Internet connectivity, video distribution, etc., and/or perform high-level security functions, such as user authentication. Although not shown in FIG. 10A, it will be appreciated that the RAN 1004 and/or the core network 1006 may be in direct or indirect communication with other RANs that employ the same RAT as the RAN 1004 or a different RAT. For example, in addition to being connected to the RAN 1004, which may be utilizing an E-UTRA radio technology, the core network 1006 may also be in communication with another RAN (not shown) employing a GSM radio technology.

The core network 1006 may also serve as a gateway for the WTRUs 1002a, 1002b, 1002c, 1002d to access the PSTN 1008, the Internet 1010, and/or other networks 1012. The PSTN 1008 may include circuit-switched telephone networks that provide plain old telephone service (POTS). The Internet 1010 may include a global system of interconnected computer networks and devices that use common communication protocols, such as the transmission control protocol (TCP), user datagram protocol (UDP) and the internet protocol (IP) in the TCP/IP internet protocol suite. The networks 1012 may include wired or wireless communications networks owned and/or operated by other service providers. For example, the networks 1012 may include another core network connected to one or more RANs, which may employ the same RAT as the RAN 1004 or a different RAT.

Some or all of the WTRUs 1002a, 1002b, 1002c, 1002d in the communications system 1000 may include multi-mode capabilities, i.e., the WTRUs 1002a, 1002b, 1002c, 1002d may include multiple transceivers for communicating with different wireless networks over different wireless links. For example, the WTRU 1002c shown in FIG. 10A may be configured to communicate with the base station 1014a, which may employ a cellular-based radio technology, and with the base station 1014b, which may employ an IEEE 802 radio technology.

FIG. 10B is a system diagram of an example WTRU 1002. As shown in FIG. 10B, the WTRU 1002 may include at least one processor 1018, a transceiver 1020, a transmit/receive element 1022, a speaker/microphone 1024, a keypad 1026, a display/touchpad 1028, non-removable memory 1030, removable memory 1032, a power source 1034, a global positioning system (GPS) chipset 1036, and other peripherals 1038. It will be appreciated that the WTRU 1002 may include any sub-combination of the foregoing elements while remaining consistent with an embodiment.

The processor 1018 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1018 may perform signal coding, data processing, power control, input/output processing, and/or any other functionality that enables the WTRU 1002 to operate in a wireless environment. The processor 1018 may be coupled to the transceiver 1020, which may be coupled to the transmit/receive element 1022. While FIG. 10B depicts the processor 1018 and the transceiver 1020 as separate components, it will be appreciated that the processor 1018 and the transceiver 1020 may be integrated together in an electronic package or chip. The processor 1018 may perform application-layer programs (e.g., browsers) and/or radio access-layer (RAN) programs and/or communications. The processor 1018 may perform security operations such as authentication, security key agreement, and/or cryptographic operations, such as at the access-layer and/or application layer for example. Thus, WTRU 1002 may include communication circuitry that establishes communication between the WTRU 1002 and a network.

In an example embodiment, the WTRU 1002 comprises a processor 1018 and memory coupled to the processor. The memory comprises executable instructions that when executed by the processor cause the processor to effectuate operations associated with invoking cryptographic functions.

The transmit/receive element 1022 may be configured to transmit signals to, or receive signals from, a base station (e.g., the base station 1014a) over the air interface 1016. For example, in an embodiment, the transmit/receive element 1022 may be an antenna configured to transmit and/or receive RF signals. In an embodiment, the transmit/receive element 1022 may be an emitter/detector configured to transmit and/or receive IR, UV, or visible light signals, for example. In yet an embodiment, the transmit/receive element 1022 may be configured to transmit and receive both RF and light signals. It will be appreciated that the transmit/receive element 1022 may be configured to transmit and/or receive any combination of wireless signals.

In addition, although the transmit/receive element 1022 is depicted in FIG. 10B as a single element, the WTRU 1002 may include any number of transmit/receive elements 1022. More specifically, the WTRU 1002 may employ MIMO technology. Thus, in an embodiment, the WTRU 1002 may include two or more transmit/receive elements 1022 (e.g., multiple antennas) for transmitting and receiving wireless signals over the air interface 1016.

The transceiver 1020 may be configured to modulate the signals that are to be transmitted by the transmit/receive element 1022 and to demodulate the signals that are received by the transmit/receive element 1022. As noted above, the WTRU 1002 may have multi-mode capabilities. Thus, the transceiver 1020 may include multiple transceivers for enabling the WTRU 1002 to communicate via multiple RATs, such as UTRA and IEEE 802.11, for example.

The processor 1018 of the WTRU 1002 may be coupled to, and may receive user input data from, the speaker/microphone 1024, the keypad 1026, and/or the display/touchpad 1028 (e.g., a liquid crystal display (LCD) display unit or organic light-emitting diode (OLED) display unit). The processor 1018 may also output user data to the speaker/microphone 1024, the keypad 1026, and/or the display/touchpad 1028. In addition, the processor 1018 may access information from, and store data in, any type of suitable memory, such as the non-removable memory 1030 and/or the removable memory 1032. The non-removable memory 1030 may include random-access memory (RAM), read-only memory (ROM), a hard disk, or any other type of memory storage device. The removable memory 1032 may include a subscriber identity module (SIM) card, a memory stick, a secure digital (SD) memory card, and the like. In other embodiments, the processor 1018 may access information from, and store data in, memory that is not physically located on the WTRU 1002, such as on a server or a home computer (not shown).

The processor 1018 may receive power from the power source 1034, and may be configured to distribute and/or control the power to the other components in the WTRU 1002. The power source 1034 may be any suitable device for powering the WTRU 1002. For example, the power source 1034 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 1018 may also be coupled to the GPS chipset 1036, which may be configured to provide location information (e.g., longitude and latitude) regarding the current location of the WTRU 1002. In addition to, or in lieu of, the information from the GPS chipset 1036, the WTRU 1002 may receive location information over the air interface 1016 from a base station (e.g., base stations 1014a, 1014b) and/or determine its location based on the timing of the signals being received from two or more nearby base stations. It will be appreciated that the WTRU 1002 may acquire location information by way of any suitable location-determination method while remaining consistent with an embodiment.

The processor 1018 may further be coupled to other peripherals 1038, which may include one or more software and/or hardware modules that provide additional features, functionality and/or wired or wireless connectivity. For example, the peripherals 1038 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 10C is a system diagram of the RAN 1004 and the core network 1006 according to an embodiment. As noted above, the RAN 1004 may employ a UTRA radio technology to communicate with the WTRUs 1002a, 1002b, 1002c over the air interface 1016. The RAN 1004 may also be in communication with the core network 1006. As shown in FIG. 10C, the RAN 1004 may include Node-Bs 1040a, 1040b, 1040c, which may each include one or more transceivers for communicating with the WTRUs 1002a, 1002b, 1002c over the air interface 1016. The Node-Bs 1040a, 1040b, 1040c may each be associated with a particular cell (not shown) within the RAN 1004. The RAN 1004 may also include RNCs 1042a, 1042b. It will be appreciated that the RAN 1004 may include any number of Node-Bs and RNCs while remaining consistent with an embodiment.

As shown in FIG. 10C, the Node-Bs 1040a, 1040b may be in communication with the RNC 1042a. Additionally, the Node-B 1040c may be in communication with the RNC 1042b. The Node-Bs 1040a, 1040b, 1040c may communicate with the respective RNCs 1042a, 1042b via an Iub interface. The RNCs 1042a, 1042b may be in communication with one another via an Iur interface. Each of the RNCs 1042a, 1042b may be configured to control the respective Node-Bs 1040a, 1040b, 1040c to which it is connected. In addition, each of the RNCs 1042a, 1042b may be configured to carry out and/or support other functionality, such as outer loop power control, load control, admission control, packet scheduling, handover control, macrodiversity, security functions, data encryption, and the like.

The core network 1006 shown in FIG. 10C may include a media gateway (MGW) 1044, a mobile switching center (MSC) 1046, a serving GPRS support node (SGSN) 1048, and/or a gateway GPRS support node (GGSN) 1050. While each of the foregoing elements are depicted as part of the core network 1006, it will be appreciated that any one of these elements may be owned and/or operated by an entity other than the core network operator.

The RNC 1042a in the RAN 1004 may be connected to the MSC 1046 in the core network 1006 via an IuCS interface. The MSC 1046 may be connected to the MGW 1044. The MSC 1046 and the MGW 1044 may provide the WTRUs 1002a, 1002b, 1002c with access to circuit-switched networks, such as the PSTN 1008, to facilitate communications between the WTRUs 1002a, 1002b, 1002c and traditional land-line communications devices.

The RNC 1042a in the RAN 1004 may also be connected to the SGSN 1048 in the core network 1006 via an IuPS interface. The SGSN 1048 may be connected to the GGSN 1050. The SGSN 1048 and the GGSN 1050 may provide the WTRUs 1002a, 1002b, 1002c with access to packet-switched networks, such as the Internet 1010, to facilitate communications between and the WTRUs 1002a, 1002b, 1002c and IP-enabled devices.

As noted above, the core network 1006 may also be connected to the networks 1012, which may include other wired or wireless networks that are owned and/or operated by other service providers.

Although features and elements are described above in particular combinations, each feature or element can be used alone or in any combination with the other features and elements. Additionally, the embodiments described herein are provided for exemplary purposes only. For example, while embodiments may be described herein using OpenID and/or SSO authentication entities and functions, similar embodiments may be implemented using other authentication entities and functions. Furthermore, the embodiments described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A user equipment (UE) for communicating with a network, the UE comprising:
communication circuitry that establishes communication between the UE and the network;
at least one processor;
a plurality of security modules, each capable of executing on the at least one processor and each implementing a different security method for securely communicating or authenticating with the network, each different security method requiring execution of one or more of a plurality of different cryptographic functions;
a plurality of cryptographic function modules, each capable of execution on the at least one processor and each configured to execute one or more of the plurality of different cryptographic functions; and
a cryptographic framework module, executing on the at least one processor, that provides a common application programming interface (API) to the security modules and that:
receives a request from a select one security module specifying a desired cryptographic type and a desired cryptographic strength required to perform the security method implemented by that security module in order to securely communicate with the network;
in response to the request, automatically invokes a select one of the cryptographic function modules iteratively, as required, to provide the requested cryptographic type and strength; and
returns a cryptographic result and information indicative of the cryptographic function used and strength achieved to the select one security module.

2. The UE as recited in claim 1, wherein the cryptographic framework module further determines a number of iterations for invoking the select one cryptographic function module to return the requested cryptographic type and strength.

3. The UE as recited in claim 1, the UE further comprising:
a secure key vault that stores symmetric keys or asymmetric keys, wherein the cryptographic framework module further retrieves keys, from the secure key vault, for the cryptographic function modules to use.

4. The UE as recited in claim 1, wherein the different security methods that are implemented by the plurality of security modules include at least one of a user authentication method, a device authentication method, a biometric authentication method, a session key generation method, an extensible authentication protocol (EAP), a generic bootstrapping architecture protocol (GBA), an OpenID method, or an internet protocol (IP) security method.

5. The UE as recited in claim 1, wherein the plurality of cryptographic functions include at least one of an encryption function, a block cipher, a stream cipher, a hashing function, a random number generator function, or a key derivation function.

6. The UE as recited in claim 1, wherein the cryptographic result includes at least one of a cipher key, an integrity key, a generic bootstrapping architecture (GBA) key, an extensible authentication protocol (EAP) key, an EAP reauthentication protocol (EAP-RP) key, a pairwise transient key, an internet protocol security key, an OpenID shared secret, or an OpenID key.

7. The UE as recited in claim 1, wherein:
the plurality of security modules reside on a kernel;
the cryptographic framework module resides on a trusted execution environment; and
the plurality of cryptographic function modules reside on a universal integrated circuit card.

8. In a system comprising a user equipment (UE) and a network entity which communicate via a network, a method for implementing at least one security protocol of the network entity to secure or authenticate communications between the UE and the network entity, the method comprising, at the UE:
receiving, via an application programming interface (API) call, a request for a cryptographic result, the requested cryptographic result associated with at least one parameter;
based on the at least one parameter, selecting a cryptographic function that satisfies the request;
invoking the selected cryptographic function to generate the requested cryptographic result; and
returning the requested cryptographic result and an identity of the invoked cryptographic function to an application.

9. The method as recited in claim 8, wherein the at least one parameter indicates a specific cryptographic function required for implementing the at least one security protocol.

10. The method as recited in claim 8, wherein the at least one parameter identifies a master key used by the selected cryptographic function to generate the cryptographic result.

11. The method as recited in claim 8, wherein the at least one parameter includes a context identity indicative of an association between the application and the at least one security protocol.

12. The method as recited in claim 8, wherein the at least one parameter is indicative of one or more characteristics of cryptographic functions, the characteristics comprising at least one of a cryptographic type, a cryptographic strength, a key length, or a cryptographic speed, and wherein selecting the cryptographic function comprises:
determining which of a plurality of cryptographic functions satisfies the one or more characteristics.

13. The method as recited in claim 8, wherein the application resides on the UE.

14. The method as recited in claim 8, wherein the at least one parameter identifies a master key used by the selected cryptographic function to generate the cryptographic result, the method further comprising:
retrieving, by the cryptographic framework module, the master key from a secure key vault residing on the UE.

15. At a user equipment (UE) comprising communication circuitry that establishes communication between the UE and a network, at least one processor, a plurality of security modules capable of executing on the at least one processor, a plurality of cryptographic function modules capable of executing on the at least one processor and each configured to execute one or more of a plurality of different cryptographic functions, and a cryptographic framework module executing on the least one processor and providing a common application programming interface (API) to the security modules, wherein each security module implements a different security method requiring execution of one of the plurality of different cryptographic functions, a method comprising:
receiving a request specifying a desired cryptographic type and a desired cryptographic strength;
in response to the request, automatically invoking a select one of the cryptographic function modules iteratively, as required, to provide the requested cryptographic type and strength; and
returning, by the cryptographic framework module, a cryptographic result and information indicative of the cryptographic function used and strength achieved to one of the plurality of security modules.

16. The method as recited in claim 15, the method further comprising:
determining a number of iterations for invoking the select one cryptographic module to return the requested cryptographic type and strength.

17. The UE as recited in claim 15, wherein the different security methods that are implemented by the plurality of security modules include at least one of a user authentication method, a device authentication method, a biometric authentication method, a session key generation method, an extensible authentication protocol (EAP), a generic bootstrapping architecture protocol (GBA), an OpenID method, or an internet protocol (IP) security method.

18. The method as recited in claim 15, wherein the plurality of cryptographic functions include at least one of an encryption function, a block cipher, a stream cipher, a hashing function, a random number generator function, or a key derivation function.

19. The method as recited in claim 15, wherein the cryptographic result includes at least one of a cipher key, an integrity key, a generic bootstrapping architecture (GBA) key, an extensible authentication protocol (EAP) key, an EAP reauthentication protocol (EAP-RP) key, a pairwise transient key, an internet protocol security key, an OpenID shared secret, or an OpenID key.

20. The method as recited in claim 15, wherein:
the plurality of security modules reside on a kernel;
the cryptographic framework module resides on a trusted execution environment; and
the plurality of cryptographic function modules reside on an universal integrated circuit card.
